(19) United States
(12) Patent Application Publication
(10) Pub. No.: US 2014/0053557 A1
(43) Pub. Date: Feb. 27, 2014

(54) MAXIMIZING VALUE FROM A CONCENTRATING SOLAR ENERGY SYSTEM

(71) Applicants: Gilad Almogy, Palo Alto, CA (US); Ratson Morad, Palo Alto, CA (US); Mani Thothadri, Mountain View, CA (US)

(72) Inventors: Gilad Almogy, Palo Alto, CA (US); Ratson Morad, Palo Alto, CA (US); Mani Thothadri, Mountain View, CA (US)

(73) Assignee: Cogenra Solar, Inc., Mountain View, CA (US)

(21) Appl. No.: 13/590,525

(22) Filed: Aug. 21, 2012

(51) Int. Cl. F03G 6/00

(52) U.S. Cl. 60/651; 60/671

(57) ABSTRACT

Systems, methods, and apparatus by which solar energy may be collected to provide electricity, heat, and/or cold are disclosed herein.

### FIELD OF THE INVENTION

The invention relates generally to the collection of solar energy to provide electric power, heat, and/or cold.

### BACKGROUND

Alternate sources of energy are needed to satisfy ever increasing world-wide energy demands. Solar energy resources are sufficient in many geographical regions to satisfy such demands, in part, by provision of electric power and useful heat.

### SUMMARY

Systems, methods, and apparatus by which solar energy may be collected to provide electricity, heat, and/or cold in any combination are disclosed herein.

A solar energy system comprises a concentrating solar energy collector coupled to provide a heat output and an electricity output to one or more applications external to the solar energy system, heat storage coupled to receive heat from the concentrating solar energy collector and to provide heat to the one or more external applications, and at least one thermally driven device coupled to provide an electricity output or a cold output to the one or more external applications and coupled to receive heat from the concentrating solar energy collector and from the heat storage. The system also comprises a controller configured to control operation of the concentrating solar energy collector, the heat storage, and the thermally driven device to maximize the total monetary value of the heat output from the concentrating solar energy collector, the electricity output from the concentrating solar energy collector, and the electricity or cold output from the thermally driven device.

The thermally driven device may be, for example, an Organic Rankine Cycle electricity generator. In such variations, the controller may operate the heat storage to provide heat from the heat storage to power the Organic Rankine Cycle electricity generator.

The thermally driven device may be instead, for example, a thermally driven chiller that provides a cold output, such as an absorption or adsorption chiller. In these variations, the controller may operate the heat storage to provide heat from the heat storage to power the chiller. In these variations the solar energy system may comprise cold storage coupled to receive a cold output from the chiller and coupled to provide a cold output to the one or more external applications.

The solar energy system may comprise electricity storage coupled to receive electricity from the concentrating solar energy collector as well as from an Organic Rankine Cycle generator or other electricity source, if the latter are present in the solar energy system. The electricity storage may provide electricity to the one or more external applications.

The solar energy system may comprise an engine-generator coupled to provide a heat output to the heat storage and to the one or more external applications and configured to provide an electricity output to the one or more external applications and to electricity storage, if the latter is present. In these variations, the controller is configured to control operation of the concentrating solar energy collector, the heat storage, the thermally driven device, and the engine-generator to maximize the total monetary value of the heat output of the concentrating solar energy collector, the electricity output from the concentrating solar energy collector, the heat output from the engine-generator, the electricity output from the engine-generator, and the electricity or cold output from the thermally driven device.

The solar energy system may comprise a heat pump coupled to provide a heat output to the heat storage and to the one or more external applications. In these variations, the controller is configured to control operation of the concentrating solar energy collector, the heat storage, the thermally driven device, and the heat pump to maximize the total monetary value of the heat output from the concentrating solar energy collector, the electricity output from the concentrating solar energy collector, the heat output from the heat pump, and the electricity or cold output from the thermally driven device.

In variations in which the thermally driven device is an Organic Rankine Cycle electricity generator, the solar energy system may also comprise a thermally driven chiller coupled to provide a cold output to the one or more external applications. These variations may also comprise cold storage coupled to receive a cold output from the chiller and coupled to provide a cold output to the one or more external applications. In such variations, the controller is configured to control operation of the concentrating solar energy collector, the heat storage, the Organic Rankine Cycle generator, the thermally driven chiller, and the cold storage (if present) to maximize the total monetary value of the heat output from the concentrating solar energy collector, the electricity output from the concentrating solar energy collector, the electricity output from the Organic Rankine Cycle generator, and the cold output from the chiller.

In any of the above variations, the controller may operate the concentrating solar energy collector at low temperature to maximize its electricity output. Alternatively, the controller may operate the concentrating solar energy collector at high temperature to maximize heat collection, operate one or more thermally driven devices at maximum capacity with heat from the concentrating solar energy collector, and store any excess heat from the concentrating solar energy collector in the heat storage. As yet another alternative, the controller may operate the concentrating solar energy collector at high temperature to maximize heat collection, store as much of the heat output as possible in the heat storage, and provide any excess heat to an external application or use it to power a thermally driven device in the system.

In any of the above variations, the controller may predict the performance of the concentrating solar energy collector, the heat storage, any thermally driven devices in the system, and/or any cold or electricity storage in the system, based on one or more weather forecasts, based on historical performance data, or based on weather forecasts and historical performance data.

In any of the above variations, the controller may predict demand from the one or more external applications for electricity, heat, and/or cold. Such demand predictions may be based, for example, on weather forecasts and/or on historical usage data.

In any of the above variations, the controller may estimate the value of electricity, heat, and cold outputs from the solar energy system from current, historical, and/or predicted energy pricing data.

In any of the above variations, the controller may control operation of the concentrating solar energy collector and other components in the solar energy system based in part on whether or not one of the external applications served by the solar energy system has received a demand from another electric power provider to reduce consumption of electric power from that provider.

In any of the above variations, the controller may assess the availability of heat from the heat storage prior to determining the optimal operation of the concentrating solar energy collector, the heat storage, the thermally driven device, and any other components in the solar energy system.

In any of the above variations, the controller may assess the cooling needs of the one or more external applications prior to determining the optimal operation of the concentrating solar energy collector, the heat storage, the thermally driven device, and any other components of the solar energy system.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 is a schematic illustration of an example solar energy system comprising a concentrating solar energy collector and additional optional components.

FIG. 2 shows a flowchart of an example control method that may be implemented by the controller of the solar energy system of FIG. 1.

FIG. 3 shows a flowchart providing additional details for a step in the method illustrated in FIG. 2.

FIG. 4 shows a flowchart providing additional details for another step in the method illustrated in FIG. 2.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. As used in this specification and the appended claims, the singular forms “a,” “an,” and “the” include plural referents unless the context clearly indicates otherwise.

Applicant has determined that the total monetary value of the solar energy collected by a concentrating solar thermal collector, or by a concentrating solar photovoltaic-thermal collector, can be maximized by appropriately choosing the use or uses of the collected solar energy, the time of use, and the operating temperature of the collector, based on value-affecting factors described below. Accordingly, this specification discloses apparatus, systems, and methods by which concentrated solar energy may be collected to provide electricity, heat, and/or cold in any suitable combination in a manner that optimizes the monetary value of the collected solar energy.

In some variations, the time at which the collected solar energy is used may be varied by temporarily storing heat, electricity, or cold for later dispatch. Electricity may be provided to an external application as, for example, direct output from the concentrating solar energy collector, output from electricity storage, or output from an Organic Rankine Cycle (ORC) generator driven by heat provided by the concentrating solar energy collector or by heat from heat storage. Heat may be provided to an external application as, for example, direct output from the concentrating solar energy collector, or output from heat storage. Cold (for example, a low temperature heat transfer fluid) may be provided to an external application as, for example, output from a thermally driven chiller powered by heat provided by the concentrating solar energy collector or by heat from heat storage, or as output from cold storage previously charged by such a thermally driven chiller. As indicated by the examples just listed, storage of electricity, heat, and cold can provide flexibility in the choice of the ultimate use of the collected solar energy as well as in the time of that use.

The value of the collected solar energy may be further enhanced by augmenting the output of the concentrating solar energy collector with other sources of heat or electricity. A heat pump driven by electricity provided from an external power grid, for example, may be used to provide additional heat. Similarly, an engine-generator fired by a fossil fuel such as natural gas may provide additional electricity as well as additional heat. The ability to draw on these additional sources of electricity and heat when desired allows further flexibility in the timing and use of the collected solar energy and thus allows further optimization of their value.

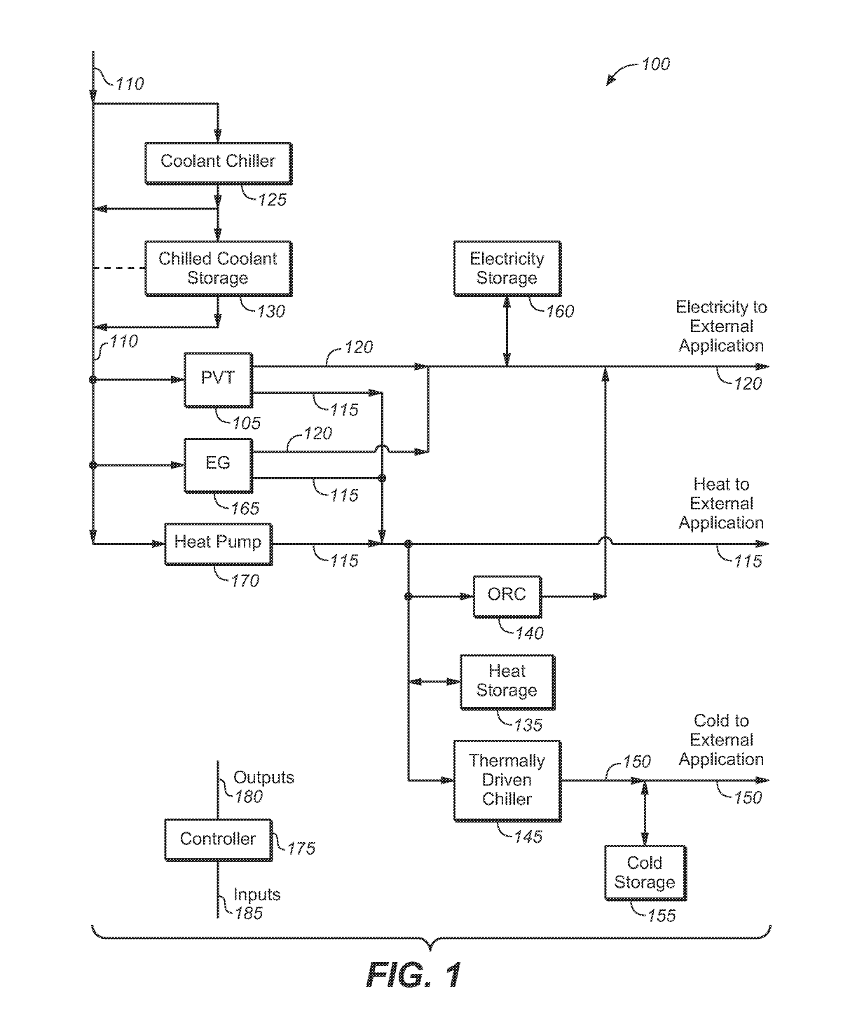

Referring now to FIG. 1, an example solar energy system 100 comprises a concentrating solar energy collector 105 as well as a number of optional additional components that will be further described below. FIG. 1 schematically shows the flow of heat, electricity, and cold through solar energy system 100 and between concentrating solar energy collector 105 and the other components of the system, when they are present. It should be understood that concentrating solar energy collector 105 may be used with any suitable combination of one or more of the components shown in FIG. 1. Further, solar energy system 100 may include additional components not shown in FIG. 1.

Concentrating solar energy collector 105 may be any suitable solar energy collector that concentrates solar radiation to provide outputs of heat or of heat and electricity. Suitable concentrating solar energy collectors may include, for example, those disclosed in U.S. patent application Ser. No. 12/712,122 titled “Designs for 1-D Concentrated Photovoltaic Systems”; U.S. patent application Ser. No. 12/788,048 titled “Concentrating Solar Photovoltaic-Thermal System”; U.S. patent application Ser. No. 12/622,416 titled “Receiver for Concentrating Solar Photovoltaic-Thermal System”; U.S. patent application Ser. No. 12/774,436 titled “Receiver for Concentrating Solar Photovoltaic Thermal System”; U.S. patent application Ser. No. 12/781,706 titled “Concentrating Solar Energy Collector”; U.S. patent application Ser. No. 13/079,193 titled “Concentrating Solar Energy Collector”; U.S. patent application Ser. No. 13/291,531 titled “Photovoltaic-Thermal Solar Energy Collector with Integrated Balance of System”; U.S. patent application Ser. No. 13/371,790 titled “Solar Cell With Metallization Compensating for or Preventing Cracking”; and Provisional U.S. Patent application 61/621,820 titled “Concentrating Solar Energy Collector”, each of which is incorporated by reference herein in its entirety.

Typically, a heat transfer fluid provided through conduit 110 passes through concentrating solar energy collector 105, where it is heated from a lower input temperature to a higher output temperature, thereby collecting heat 115 which is then output from concentrating solar energy collector 105. Generally, heat 115 is transported through solar energy system 100 by heat transfer fluid that is propelled through conduits by pumps and directed to desired locations by valves. Such conduits, pumps, and valves are not shown in FIG. 1 but may be located as suitable to support operation of system 100 as described in this specification. The collected heat 115 output from concentrating solar energy collector 105 may be carried, for example, by heat transfer fluid that was heated in the concentrating solar energy collector, or by heat transfer fluid that is heated by heat exchange with heat transfer fluid that was heated in the concentrating solar energy collector.

Typically, heat transfer fluid is heated by passage through concentrating solar energy collector 105, delivers the collected heat it carries to another heat transfer fluid, to a use for the heat, or to heat storage, and then returns to concentrating solar energy collector 105 at a reduced temperature through a recirculation loop. To avoid cluttering FIG. 1, such heat transfer fluid recirculation loops are not shown for concentrating solar energy collector 105 or for any of the other components of system 100 for which such recirculation loops may be used.

Any suitable heat transfer fluids may be used with solar energy system 100 described herein. Suitable heat transfer fluids may include, for example, water, ethylene glycol, water/ethylene glycol mixtures, other water/alcohol mixtures, and heat transfer oils. Any suitable conduits, pumps, and valves may be used.

Concentrating solar energy collector 105 may be a photovoltaic-thermal (PVT) concentrating solar energy collector that comprises solar cells that convert solar radiation directly to electricity 120. The efficiency with which solar cells produce electricity typically decreases as their temperature increases. The monetary value of the electricity output from the solar cells in a PVT concentrating solar energy collector 105 thus typically decreases as the operating temperature of the concentrating solar energy collector increases, assuming a constant price for electricity. In contrast, the monetary value of the heat output by the concentrating solar energy collector typically increases as temperature increases. The total monetary value of the heat and electricity output from concentrating solar energy collector 105 may therefore vary with its operating temperature, with the optimum operating temperature depending on the price of electricity and the monetary value of the use or uses chosen for the heat. The price of electricity may change with time, during the course of a day for example. The monetary value of a use of the heat may change with the choice of use, and the value for any particular use may change with time and with the temperature at which the heat is provided.

The operating temperature of concentrating solar energy collector 105 is determined by the temperature of the heat transfer fluid as it enters the concentrating solar energy collector and the rate at which it flows through the concentrating solar energy collector, assuming a constant level of solar radiation collection. In some variations, heat transfer fluid is chilled by a chiller 125 prior to entering concentrating solar energy collector 105, in order to reduce the operating temperature of the concentrating solar energy collector and thereby increase the efficiency with which solar cells in the concentrating solar energy collector produce electricity. (Heat transfer fluid is also referred to herein as “coolant”). In some of these variations, chilled heat transfer fluid is stored in chilled storage 130, and later dispatched to concentrating solar energy collector 105 when a boost in the efficiency of the solar cells is desired. Dispatching stored chilled coolant in this manner is referred to herein as “boost mode” operation. Chiller 125 may be, for example, a forced air fin-fan heat exchanger or any other suitable chiller. Chilled coolant storage 130 may comprise any suitable storage vessel.

In some variations, concentrating solar energy collector 105 may be run in a low temperature “heat dump” mode in which heat is rapidly extracted from the concentrating solar energy collector using local cooling of the heat transfer fluid, after which the heat transfer fluid is recirculated through the concentrating solar energy collector. The heat transfer fluid may be cooled, for example, by a separate but locally placed chiller such as chiller 125, or by heat exchangers integrated with the concentrating solar energy collector. Such integrated heat exchangers may be shaded by the concentrating solar energy collector, and may include, for example, finned tubes as described in U.S. patent application Ser. No. 12/788, 048 titled “Concentrating Solar Photovoltaic-Thermal system”. The heat dump mode of operation may be used, for example, to maximize the electricity output of the concentrating solar energy collector or when there is insufficient demand for the collected heat. The heat transfer fluid may be circulated through the concentrating solar energy collector at a flow rate greater than that used during normal operation. Typically, in heat dump mode little or no heat is delivered to other components of system 100 or to an external application.

In some variations, concentrating solar energy collector 105 comprises thin film Gallium Arsenide (GaAs) solar cells. Such thin film GaAs solar cells may have a low thermal coefficient of, for example −0.12%/° C., or of even lower magnitude. As a result, their efficiency decreases with increasing temperature more slowly than that for conventional silicon solar cells and they may operate efficiently in a temperature range, for example, of about 90° C. to about 120° C. The use of such GaAs cells may allow the concentrating solar energy collector to be operated at elevated temperatures providing higher value heat without significantly decreasing the value of the electricity provided by the collector. Suitable GaAs solar cells for use in concentrating solar energy collector 105 may include those available from Alta Devices, Inc., for example.

Referring again to FIG. 1, heat 115 output from concentrating solar energy collector 105 may be directed, for example, to an external application, to heat storage 135, to ORC generator 140, or to thermally driven chiller 145. If heat storage 135 has been previously charged, heat may also be directed from heat storage 135 to ORC 140, to chiller 145, or to an external application.

Heat storage 135 may store heat in the form of hot heat transfer fluid, for example. Any suitable storage vessel may be used for that purpose. Alternatively, or in addition, heat storage 135 may store heat using phase-change or thermo-chemical systems, or using any other suitable method. Heat storage 135 may have a capacity, for example, equal to about one day's typical output of heat from concentrating solar energy collector 105.

ORC 140 may be any suitable low temperature Rankine cycle generator, such as, for example, a Clean Cycle 125 Rankine cycle generator manufactured by General Electric, Inc. Such ORC generators may operate efficiently when powered with heat provided in a temperature range, for example, of about 90° C. to about 130° C., with efficiency increasing with temperature. The efficiency of ORC generators may be affected by the temperature and humidity of the ambient environment, with efficiency decreasing as ambient temperature or humidity increase. These factors may therefore play a role in determining whether or not powering the ORC 140 is an optimal use of heat from solar collector 105 or from heat storage 135 at any particular time.

In some variations, ORC 140 may be configured to be powered either by heat drawn from the heat sources shown in FIG. 1 or by heat drawn from a separate fossil-fuel burning heat source (not shown), which may be co-located with ORC 140.

Thermally driven chiller 145 may be, for example, any suitable absorption chiller or adsorption chiller, such as, for example, a model YIA-HW-1A1-46-C chiller manufactured by Johnson Controls, Inc. Such chillers may operate efficiently when powered by heat provided in a temperature range, for example, of about 90° C. to about 130° C., with efficiency increasing with temperature. Similarly to the ORC, the efficiency of such chillers may be affected by the temperature and humidity of the ambient environment, with efficiency decreasing as ambient temperature or humidity increase. These factors may therefore play a role in determining whether or not powering thermally driven chiller 145 is an optimal use of heat from solar collector 105 or from heat storage 135 at any particular time.

In some variations, thermally driven chiller 145 may be configured to be powered either by heat drawn from the heat sources shown in FIG. 1 or by heat drawn from a separate fossil-fuel burning heat source (not shown), which may be co-located with chiller 145.

The cold output 150 from thermally driven chiller 145 may be provided in the form of chilled heat transfer fluid, for example. Cold output 150 may be delivered to an external application or stored in cold storage 155. Cold storage 155 may, for example, store chilled heat transfer fluid in any suitable storage vessel. Alternatively, cold storage 155 may store cold in the form of water ice, by using other phase-change systems, or using any other suitable method. Cold storage 155 may have a capacity, for example, equal to about one day's typical output from thermally driven chiller 145 assuming chiller 145 is powered by the entire heat output from solar collector 105. If cold storage 155 has previously been charged, cold output from cold storage 155 may be delivered to an external application. Thermally driven chiller 145 and cold storage 155 may optionally substitute for coolant chiller 125 and chilled coolant storage 130 to provide chilled heat transfer fluid to concentrating solar energy collector 105. Chilled heat transfer fluid for “boost mode” operation may optionally be drawn from cold storage 155, for example.

Electricity 120 output from concentrating solar energy collector 105 may be provided to an external application or stored in electricity storage 160. Electricity storage 160 may comprise batteries, for example, or store electricity in any other suitable manner. Electricity storage 160 may have a capacity, for example, equal to about one day's typical output of electricity from concentrating solar energy collector 105.

Engine-generator 165 may be any suitable fossil-fuel powered generator such as, for example, a model 11060-E66TAG4 engine-generator manufactured by Perkins, Inc. Generally, engine-generator 165 is operated as a combined heat and power (CHP) source that can provide electricity 120 and heat 115 to external applications or to other components of system 100 as illustrated in FIG. 1. Engine-generator 165 may operate in parallel with concentrating solar energy collector 105 or instead of concentrating solar energy collector 105.

Heat pump 170 may be any suitable heat pump such as, for example, a model XB13 heat pump manufactured by Trane, Inc. Heat pump 170 may be powered with electricity from an external power grid or, optionally, electricity provided by solar collector 105, ORC 140, or electricity storage 160. Heat pump 170 can provide heat 115 to external applications or to other components of system 100 as illustrated in FIG. 1. Heat pump 170 may operate in parallel with concentrating solar energy collector 105 and engine-generator 165, or instead of either of them.

External applications for electricity 120 may include, for example, providing electricity to an external grid or to a local application. Solar energy system 100 may include inverters and/or other suitable balance of system components typically used in providing electricity from a photovoltaic solar energy collector to a use of the electricity. External applications for heat 115 may include, for example, any suitable industrial, agricultural, or domestic application. External applications for cold 150 may include, for example, air conditioning or any other suitable industrial, agricultural, or domestic application.

Controller 175 provides outputs 180 controlling the components of solar energy system 100 and controlling the flow of electricity, heat, and cold through the system, based on inputs 185. Controller 175 may be implemented using any suitable combination of software, hardware, or firmware, and may be implemented on a general purpose computer. Control signals output from controller 175 may be delivered to the various components of solar energy system 100 by any suitable method, including wireless communication or through electrical or optical cables. Similarly, inputs 185 may be provided to controller 175 by any suitable method. Inputs 185 and outputs 180 such as those described below may be stored in memory in controller 175 and updated over time as appropriate.

Generally, controller 175 controls operation of solar energy system 100 to maximize the monetary value of the output of solar energy system 100. Inputs 185 to controller 175 typically include models that predict the performance of the various components of solar energy system 100 under various conditions. For example, a model of concentrating solar energy collector 105 may estimate its heat and electricity output as a function of the intensity of incident solar radiation, the ambient temperature and wind conditions, and/or the initial temperature and flow rate of heat transfer fluid through the concentrating solar energy collector. A model of ORC 140 may estimate its output as a function of ambient temperature, humidity, and wind conditions and/or the temperature at which heat is provided to power it. Similarly, a model of thermally driven chiller 145 may estimate its output as a function of ambient temperature, humidity, and wind conditions and/or the temperature at which heat is provided to power it. Models of heat storage 135, cold storage 155, and electricity storage 160 may include their storage capacity and their current charge level, and estimate their charging and discharging rates as a function of current charge level and ambient conditions. A model of engine-generator 165 may include its maximum heat and electricity output and the price of its fuel, and estimate its electricity and heat output as a function of fuel usage. A model of heat pump 170 may include its maximum heat output and the price paid for electricity to power it, and estimate its heat output as a function of electricity usage.

Inputs 185 to controller 175 may also include parameters characterizing the electricity, heat, and cooling usage profiles of external applications served by solar energy system 100. These profiles may include, for example, historical or predicted usage as a function of time at sub-hourly, hourly, or daily intervals through an entire calendar year. Related inputs may include parameters characterizing historical, current, or predicted utility rates (prices) as a function, for example, of time of day, time of week, time of year, and/or peak usage for electricity, natural gas, and/or any other commercially provided energy source that may be displaced by the output of solar energy system 100.

Additional inputs 185 to controller 175 may include, for example, the current operating status of all components in solar energy system 100, the current outputs of electricity, heat, and cold from solar energy system 100 to external applications, the current and forecast weather including ambient temperature and direct normal incidence (DNI) of solar radiation, the current and predicted demand from external applications for heat, cold, and/or electricity from solar energy system 100, the current and predicted temperature of buildings that are or may be cooled using cold output from solar energy system 100.

Another possible input to controller 175 is a “Demand Response Command” (DRC). Solar energy system 100 may provide electricity, heat, and/or cold to a user that also receives electricity service from a utility. A DRC is an instruction from the utility to such a user that the user must reduce demand for electricity from the utility to below some particular level during some particular time interval. To reduce demand as required, the user must reduce power consumption, substitute power from another source, or both reduce consumption and substitute power from another source. Such a DRC may be, for example, provided directly to controller 170 by the utility or may be communicated by the user to controller 170. In response to the DRC, controller 170 may control solar energy system 100 to provide the combination of heat, electricity, and/or cold to the user in a manner that is most valuable to the user in its effort to satisfy the requirements of the DRC.

In return for agreeing to respond to DRCs, the user may pay lower rates for electricity provided by the utility. Consequently, solar energy system 100 may provide monetary value to a user simply by enabling the user to respond effectively to a DRC.

Outputs 180 from controller 175 may include, for example: signals to pumps, valves, and switches to route heat, cold, and electricity through solar energy system 100 as required; signals controlling the input temperature and flow rate of heat transfer fluid through concentrating solar energy collector 105; signals to operate concentrating solar energy collector 105 in boost mode or in heat dump mode as described above; signals to operate or turn-off an engine-generator, heat pump, ORC, or thermally driven chiller; signals to store electricity, heat, or cold; and signals to draw electricity, heat, or cold from storage.

Controller 170 may use any suitable algorithm to control solar energy system 100 to maximize the monetary value of its output. The algorithm may, for example, use weather forecasts and historical data to predict the output of concentrating solar energy collector 105, the impact of the weather on the efficiency with which other components of system 100 produce or store electricity, heat, or cold, and expected demand for electricity, heat, or cold from external applications. In addition, the algorithm may use energy pricing inputs discussed above to estimate the current and future value of electricity, heat, and cold output from solar energy system 100. Taking into account these predictions and the current charge state of electricity, heat, and cold storage, the algorithm may then evaluate the merits of operating the various components of system 100 in their various possible modes of operation to determine what operational mode currently maximizes the monetary value of the output of solar energy system 100. In this process the algorithm may consider, for example, that as explained above heat generated in solar energy system 100 can be stored and upon demand be converted to electricity using ORC 140 or used to reduce demand for electricity by, for example, driving chiller 145 on demand, or by driving chiller 145 in advance and then storing the output in cold storage 155.

Controller 170 may operate solar energy system 100 and its components in various modes, including, for example: 1) low temperature operation of concentrating solar energy collector 105 to optimize electrical output, including possibly operating in boost mode or heat dump mode as described above; 2) high temperature operation of concentrating solar energy collector 105 to maximize heat collection with immediate use of heat to drive ORC 140 or chiller 145 and storage of excess heat—the extra electricity generated by the ORC or the electric power usage displaced from an external application by provision of cold from chiller 145 may have a monetary valued exceeding that of the electrical output lost from concentrating solar energy collector 105 as a result of high temperature operation; 3) high temperature operation of concentrating solar energy collector 105 with full or partial storage of the heat for later use; 4) drawing electricity from the external power grid to produce heat with heat pump 170, or by any other suitable method, with immediate use of the heat for an external application of heat or for powering ORC 140 or chiller 145, or storage and later use for any of those purposes; 5) operation of engine-generator 165 to produce heat and electricity for immediate use for any of the applications shown in FIG. 1, or for storage and later use for any of the applications shown in FIGS. 1; and 6) storing all electricity output from concentrating solar energy collector 105 or reducing the electricity output of concentrating solar energy collector 105 by running it at high temperature and/or reducing its collection of solar energy in order to reduce or stop supplying electricity to an external application such as an external power grid.

In one example, solar energy system 100 comprises a PVT concentrating solar energy collector 105 with peak electricity generation of 1 KW and peak heat generation of 4 KW at 120 C. This enables ORC 140 to run at 10% efficiency, which can provide another 0.4 kW of electricity. A peak demand charge for electricity is high between noon and 6 PM. The peak demand charge is $20/kw, peak electricity is 10 c/kwhr, and natural gas is 4 cents/kwhr of heat. ORC 140 has a maximal capacity of 0.4 kW. Heat storage 135 is empty at noon. This system may be run, for example, in the following modes: 1a) condition: concentrating solar energy collector 105 is predicted to generate at full rated capacity from noon to 6 PM, decision: run PVT concentrating solar energy collector 105 at high temperature and run ORC 140 continuously with all generated heat; 1b) PVT concentrating solar energy collector 105 is predicted to run at half capacity noon to 6 PM, customer's demand is flat, decision: run PVT concentrating solar energy collector 105 at high temperature and run ORC 140 continuously with all (limited) generated heat; 1c) extremely hot and humid weather impacts the efficiency of ORC 140 more than it affects the efficiency of photovoltaic electricity production in PVT concentrating solar energy collector 105 (for example, in case of PV with low thermal coefficient cells), decision: run PVT concentrating solar energy collector 105 in heat dump mode; 1d) concentrating solar energy collector 105 is predicted to run at ⅙th capacity, customer's demand peaks for 1 hour between 5 and 6 PM, decision: run concentrating solar energy collector 105 at high temperature and store all generated heat until 5 PM, run ORC 140 at maximum capacity from 5 to 6 PM; 1e) no time of use (TOU) tariff differences, no demand (power) charges, and a large day to night temperature difference as in high desert, for example, decision: store the heat output from concentrating solar energy collector 105 all day and run ORC 140 from the stored heat in the coldest night/early morning hours; 1f) weather forecast on day-1 predicts poor sun conditions on day-2, absence of 200 KW PV could trigger a new peak on day-2, decision: store the heat output from concentrating solar energy collector 105 all day on day-1 and run ORC 140 at full capacity on day 2 to avoid a new higher peak in demand for that billing period; 1g) use live demand data from a smart meter and/or cloud cover weather data to trigger ORC 140 production of electricity when the solar cells in concentrating solar energy collector 105 are not producing to avoid demand peaks.

In another example; controller 170 or a user receive a DRC (described above) when the sun is shining and the heat storage is at least partially charged, decision: start running PVT concentrating solar energy collector 105 at low temperature to maximize output (for example, in “boost mode” or “heat dump” mode) while simultaneously running ORC 140 and/or chiller 145 at full capacity with the stored heat.

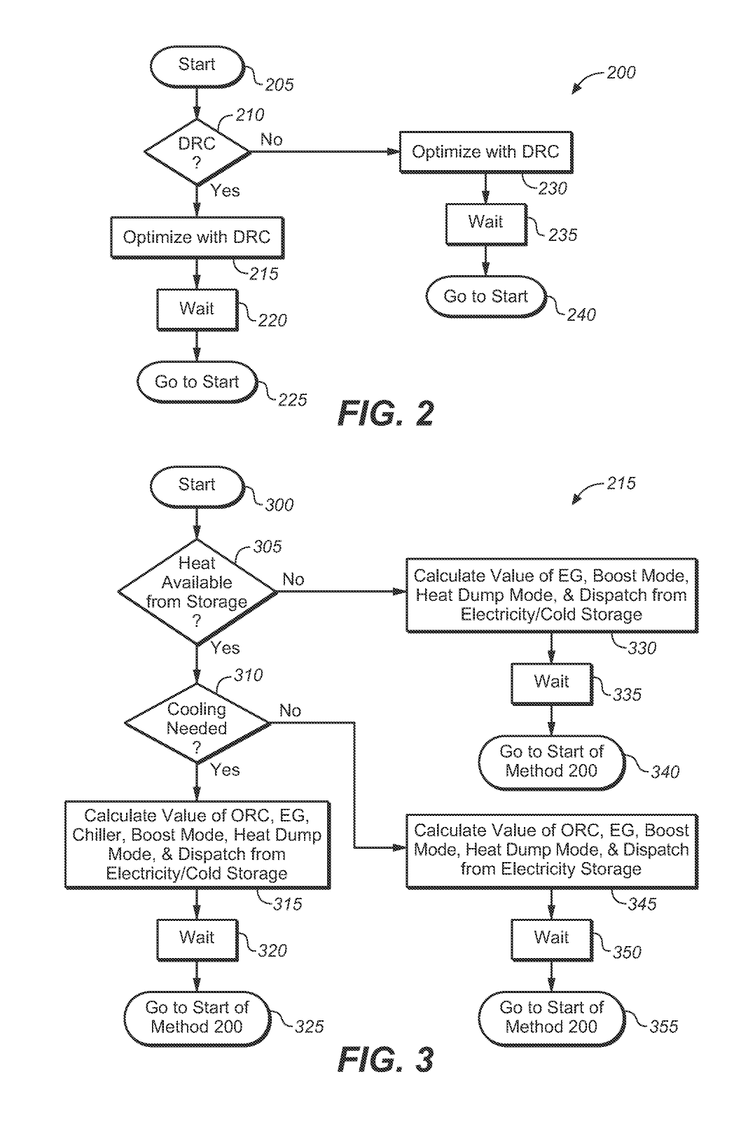

Referring now to the flow chart in FIG. 2, controller 175 may implement method 200, for example, in controlling solar energy system 100. At step 210 in method 200, controller 175 determines whether or not a Demand Response Command has been received. If so, the method proceeds to step 215 at which the operation of solar energy system 100 is optimized to maximize monetary value under the constraint of satisfying the Demand Response Command. Next, at step 220, controller 175 pauses for an interval of, for example, about 1 minute, about 5 minutes, about 15, minutes, or about 30 minutes or longer before returning to the start of method 200 and again determining the DRC status. If at step 210 controller 175 determines that no DRC has been received, the method proceeds to step 230 at which the operation of solar energy system 100 is optimized to maximize monetary value without the constraint of satisfying the Demand Response Command. From step 230 the method proceeds to step 235, where controller 175 pauses for an interval of, for example, about 1 minute, about 5 minutes, about 15, minutes, or about 30 minutes or longer before returning to the start of method 200 and again determining the DRC status.

FIG. 3 shows additional details of step 215 (optimize with DRC) of method 200. In step 305, controller 175 determines whether or not there is heat available from heat storage 135. If not, the method proceeds to step 330. At step 330, controller 175 determines the monetary value of operating engine-generator 165, operating concentrating solar energy collector 105 in boost mode or heat dump mode, dispatching electricity to the external user from electricity storage 160 (if available), and/or dispatching cold to the external user from cold storage 155 (if available). After determining the optimum combination of these actions, controller 175 sends control signals to these components accordingly. From step 330 the method proceeds to step 335, where controller 175 pauses for an interval of, for example, about 1 minute, about 5 minutes, about 15, minutes, or about 30 minutes or longer before returning to the start of method 200 and again determining the DRC status.

If at step 305 controller 175 determines that there is heat available from heat storage 135, the method proceeds to step 310. At step 310, controller 175 determines whether or not the external user requires cooling. If not, the method proceeds to step 345 at which controller 175 determines the monetary value of operating ORC 140 from stored heat, operating engine-generator 165, operating concentrating solar energy collector 105 in boost mode or heat dump mode, and dispatching electricity to the external user from electricity storage 160 (if available). After determining the optimum combination of these actions, controller 175 sends control signals to these components accordingly. From step 345 the method proceeds to step 350, where controller 175 pauses for an interval of, for example, about 1 minute, about 5 minutes, about 15, minutes, or about 30 minutes or longer before returning to the start of method 200 and again determining the DRC status.

If at step 310 controller 175 determines that the external user requires cooling, the method proceeds to step 315 at which controller 175 determines the monetary value of operating ORC 140 from stored heat, operating engine-generator 165, operating chiller 145 from stored heat, operating concentrating solar energy collector 105 in boost mode or heat dump mode, dispatching electricity to the external user from electricity storage 160 (if available), and dispatching cold to the external user from cold storage 155 (if available). After determining the optimum combination of these actions, controller 175 sends control signals to these components accordingly. From step 315 the method proceeds to step 320, where controller 175 pauses for an interval of, for example, about 1 minute, about 5 minutes, about 15, minutes, or about 30 minutes or longer before returning to the start of method 200 and again determining the DRC status.

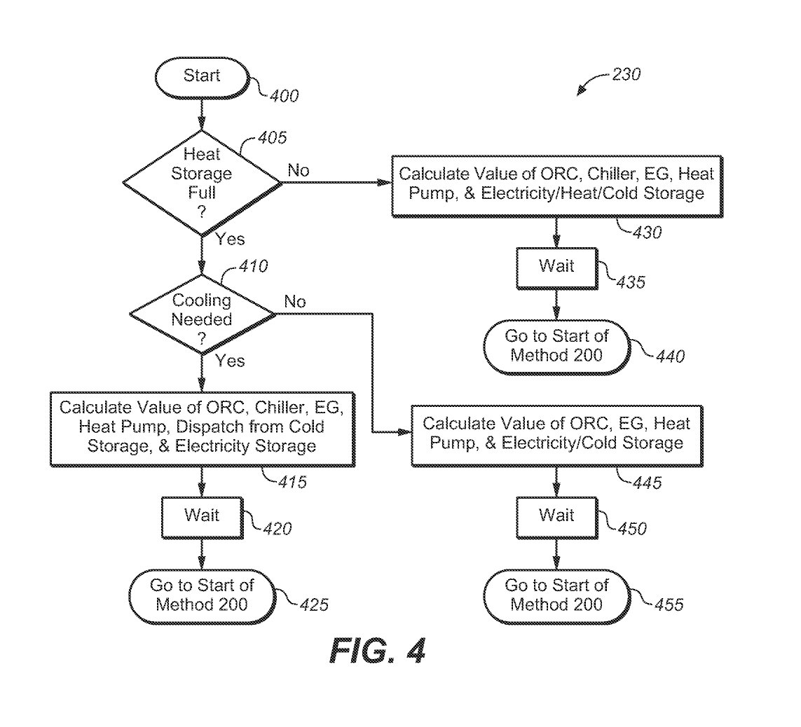

FIG. 4 shows additional details of step 230 (optimize without DRC) of method 200. In step 405, controller 175 determines whether or not heat storage 135 is full. If not, the method proceeds to step 430. At step 430, controller 175 determines the monetary value of operating ORC 140 with heat from concentrating solar energy collector 105 or with heat from heat storage 135, operating chiller 145 with heat from concentrating solar energy collector 105 or with heat from heat storage 135, operating engine-generator 165, operating heat pump 170, charging electricity storage 160, dispatching electricity to the external user from electricity storage 160 (if available), charging heat storage 135, charging cold storage 155, and/or dispatching cold to the external user from cold storage 155 (if available). After determining the optimum combination of these actions, controller 175 sends control signals to these components accordingly. From step 430 the method proceeds to step 435, where controller 175 pauses for an interval of, for example, about 1 minute, about 5 minutes, about 15, minutes, or about 30 minutes or longer before returning to the start of method 200 and again determining the DRC status.

If at step 405 controller 175 determines that heat storage 135 is full, the method proceeds to step 410. At step 410, controller 175 determines whether or not the external user requires cooling. If not, the method proceeds to step 445 at which controller 175 determines the monetary value of operating ORC 140 with heat from concentrating solar energy collector 105 or with heat from heat storage 135, operating chiller 145 with heat from concentrating solar energy collector 105 or with heat from heat storage 135 and then storing the output in cold storage 155, operating engine-generator 165, operating heat pump 170, charging electricity storage 160, and/or dispatching electricity to the external user from electricity storage 160 (if available). After determining the optimum combination of these actions, controller 175 sends control signals to these components accordingly. From step 445 the method proceeds to step 450, where controller 175 pauses for an interval of, for example, about 1 minute, about 5 minutes, about 15, minutes, or about 30 minutes or longer before returning to the start of method 200 and again determining the DRC status.

If at step 410 controller 175 determines that the external user requires cooling, the method proceeds to step 415 at which controller 175 determines the monetary value of operating ORC 140 with heat from concentrating solar energy collector 105 or with heat from heat storage 135, operating chiller 145 with heat from concentrating solar energy collector 105 or with heat from heat storage 135, operating engine-generator 165, operating heat pump 170, charging electricity storage 160, dispatching electricity to the external user from electricity storage 160 (if available), and/or dispatching cold from cold storage 155 (if available). After determining the optimum combination of these actions, controller 175 sends control signals to these components accordingly. From step 415 the method proceeds to step 420, where controller 175 pauses for an interval of, for example, about 1 minute, about 5 minutes, about 15, minutes, or about 30 minutes or longer before returning to the start of method 200 and again determining the DRC status.

This disclosure is illustrative and not limiting. Further modifications will be apparent to one skilled in the art in light of this disclosure and are intended to fall within the scope of the appended claims.

What is claimed is:

1. A solar energy system comprising:
a concentrating solar energy collector coupled to provide a heat output and an electricity output to one or more external applications;
heat storage coupled to receive heat from the concentrating solar energy collector and to provide heat to the one or more external applications;
at least one thermally driven device coupled to provide an electricity output or a cold output to the one or more external applications, the thermally driven device coupled to receive heat from the concentrating solar energy collector and from the heat storage; and
a controller configured to control operation of the concentrating solar energy collector, the heat storage, and the thermally driven device to maximize the total monetary value of the heat output from the concentrating solar energy collector, the electricity output from the concentrating solar energy collector, and the electricity or cold output from the thermally driven device.

2. The solar energy system of claim 1, wherein the thermally driven device is an Organic Rankine Cycle electricity generator.

3. The solar energy system of claim 2, wherein the controller is configured to operate the heat storage to provide heat from the heat storage to power the Organic Rankine Cycle electricity generator.

4. The solar energy system of claim 1, wherein the thermally driven device is a chiller that provides a cold output.

5. The solar energy system of claim 4, wherein the controller is configured to operate the heat storage to provide heat from the heat storage to power the chiller.

6. The solar energy system of claim 4, comprising cold storage coupled to receive a cold output from the chiller and coupled to provide a cold output to the one or more external applications.

7. The solar energy system of claim 1, comprising electricity storage coupled to receive electricity from the concentrating solar energy collector.

8. The solar energy system of claim 1, comprising an engine-generator coupled to provide a heat output to the heat storage or to the one or more external applications and coupled to provide an electricity output to the one or more external applications, wherein the controller is configured to control operation of the concentrating solar energy collector, the heat storage, the thermally driven device, and the engine-generator to maximize the total monetary value of the heat output from the concentrating solar energy collector, the electricity output from the concentrating solar energy collector, the heat output from the engine-generator, the electricity output from the engine-generator, and the electricity or cold output from the thermally driven device.

9. The solar energy system of claim 1, comprising a heat pump coupled to provide a heat output to the heat storage or to the one or more external applications, wherein the controller is configured to control operation of the concentrating solar energy collector, the heat storage, the thermally driven device, and the heat pump to maximize the total monetary value of the heat output from the concentrating solar energy collector, the electricity output from the concentrating solar energy collector, the heat output from the heat pump, and the electricity or cold output from the thermally driven device.

10. The solar energy system of claim 2, comprising a thermally driven chiller coupled to provide a cold output to the one or more external applications, wherein the controller is configured to control operation of the concentrating solar energy collector, the heat storage, the Organic Rankine Cycle generator, and the thermally driven chiller to maximize the total monetary value of the heat output from the concentrating solar energy collector, the electricity output from the concentrating solar energy collector, the electricity output from the Organic Rankine Cycle generator, and the cold output from the chiller.

11. The solar energy system of claim 10, comprising cold storage coupled to receive a cold output from the chiller and coupled to provide a cold output to the one or more external applications.

12. The solar energy system of claim 1, wherein the controller is configured to operate the concentrating solar energy collector to maximize its electricity output.

13. The solar energy system of claim 1, wherein the controller is configured to operate the concentrating solar energy collector at high temperature to maximize heat collection, operate the thermally driven device at maximum capacity with heat from the concentrating solar energy collector, and store any excess heat from the concentrating solar energy collector in the heat storage.

14. The solar energy system of claim 1, wherein the controller is configured to operate the concentrating solar energy collector at high temperature to maximize heat collection and store the heat in heat storage.

15. The solar energy system of claim 1, wherein the controller is configured to predict the performance of the concentrating solar energy collector, the heat storage, and the thermally driven device based on one or more weather forecasts, historical performance data, or weather forecasts and historical performance data.

16. The solar energy system of claim 1, wherein the controller is configured to predict demand from the one or more external applications for electricity, heat, or cold.

17. The solar energy system of claim 1, wherein the controller is configured to estimate the value of electricity, heat, and cold outputs from the solar energy system from energy pricing data.

18. The method of claim 1, wherein the controller is configured to control operation of the concentrating solar energy collector based in part on whether or not one of the external applications has received a demand from an electric power provider to reduce consumption of electric power from that provider.

19. The method of claim 18, wherein the controller is configured to assess the availability of heat from the heat storage prior to determining the operation of the concentrating solar energy collector, the heat storage, and the thermally driven device that maximizes the total monetary value of the heat output from the concentrating solar energy collector, the electricity output from the concentrating solar energy collector, and the electricity or cold output from the thermally driven device.

20. The method of claim 19, wherein the controller is configured to assess the cooling needs of the one or more external applications prior to determining the operation of the concentrating solar energy collector, the heat storage, and the thermally driven device that maximizes the total monetary value of the heat output from the concentrating solar energy collector, the electricity output from the concentrating solar energy collector, and the electricity or cold output from the thermally driven device.
